(19) United States
(12) Patent Application Publication
(10) Pub. No.: US 2023/0118834 A1
(43) Pub. Date: Apr. 20, 2023

(54) LIGHT EMITTING MARKER AND ASSAY

(71) Applicant: Sumitomo Chemical Co., Ltd., Tokyo (JP)

(72) Inventors: Sheena Zuberi, Godmanchester (GB); Jeremy Burroughes, Godmanchester (GB); Nazrul Islam, Godmanchester (GB)

(73) Assignee: Sumitomo Chemical Co., Ltd., Tokyo (JP)

(21) Appl. No.: 17/913,716

(22) PCT Filed: Mar. 23, 2021
(86) PCT No.: PCT/EP2021/057482

§ 371 Date: Sep. 22, 2022

(30) Foreign Application Priority Data
Mar. 24, 2020 (GB) 2004250.3

(51) Int. Cl. G01N 15/10; G01N 15/14; C09K 11/63; C08G 61/12

(52) U.S. Cl. CPC G01N 15/1012; G01N 15/1459; C09K 11/63; C08G 61/122; G01N 2015/1018; C08G 2261/3247

(57) ABSTRACT

A method of identifying a target analyte in which a sample containing a light-emitting marker configured to bind to the target analyte is irradiated and emission from the light-emitting marker is detected. The light-emitting marker comprises a light-emitting material comprising a group of formula (I): X is one of N and B and Y is the other of N and B; Ar¹ and Ar² independently are an unsubstituted or substituted an aromatic or heteroaromatic group which is unsubstituted or substituted with one or more substituents. Ar1 and Ar2 bound to the same X group may be linked by a direct bond or a divalent group. The group of formula (I) may be a repeat unit of a light-emitting polymer. The light-emitting marker may be used in flow cytometry.

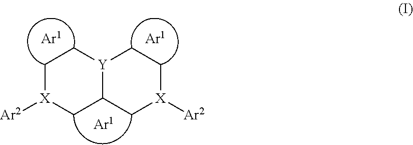

### BACKGROUND

Embodiments of the present disclosure relate to light-emitting markers. Embodiments of the present disclosure further relate to methods of identifying a target analyte using said light-emitting marker.

Light-emitting materials have been disclosed for marking a target analyte. WO 2018/060722 discloses composite particles comprising a mixture of silica and a light-emitting polymer having polar groups.

Kondo et al, “Narrowband deep-blue organic light-emitting diode featuring an organoboron-based emitter”, Nat. Photonics 13, 678-682 (2019) discloses a luminescent material for a full colour display consisting of five benzene rings connected by two boron and four nitrogen atoms and two diphenylamino substituents.

### SUMMARY

In some embodiments, the present disclosure provides a method of identifying a target analyte in a sample, the method comprising irradiating the sample to which has been added a first light-emitting marker configured to bind to the target analyte; and detecting emission from the first light-emitting marker, wherein the first light-emitting marker comprises a light-emitting material comprising a group of formula (I):

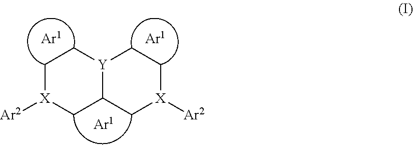

wherein X is one of N and B;

Y is the other of N and B;

Ar¹ independently in each occurrence is an aromatic or heteroaromatic group which is unsubstituted or substituted with one or more substituents;

Ar² in each occurrence is an aromatic or heteroaromatic group which is unsubstituted or substituted with one or more substituents; and

Ar¹ and Ar² bound to the same X group may be linked by a direct bond or a divalent group.

Optionally, the light-emitting material is a polymer comprising a repeat unit comprising a group of formula (I).

Optionally, the light-emitting material is a polymer comprising a repeat unit of formula (Ir):

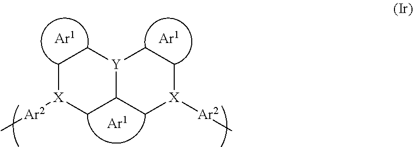

Optionally, the light-emitting polymer is a copolymer comprising a repeat unit comprising formula (I) and at least one co-repeat unit.

Optionally, the polymer comprises a C₆₋₂₀ arylene co-repeat unit.

Optionally, the light-emitting marker comprises a biomolecule configured to bind to the target analyte.

Optionally, the light-emitting material has a solubility in water or a C₁₋₆ alcohol of at least 0.1 mg/ml.

Optionally, the light-emitting material is substituted with at least one ionic substituent.

Optionally, the light-emitting material is substituted with at least one group of formula (III):

—O(R⁴O)ᵥ—R⁵ (III)

wherein R⁴ in each occurrence is a C₁₋₁₀ alkylene group wherein one or more non-adjacent, non-terminal C atoms of the alkylene group may be replaced with O, R⁵ is H or C₁₋₅ alkyl, and v is 0 or a positive integer.

Optionally, the light-emitting material has a peak emission wavelength (λ_{Em}) in the range of 400-500 nm.

Optionally, the light-emitting material has an emission peak having a full width at half maximum of less than 50 nm.

Optionally, the sample comprises one or more additional light-emitting markers wherein each of the one or more additional light-emitting markers emits light having an emission peak which is different from that of the first light-emitting marker.

Optionally, the method is a flow cytometry method and the target analyte is a target cell.

Optionally, a biomolecule capable of binding to the target analyte is bound to the light-emitting material.

Optionally, the first light-emitting marker is dissolved in the sample.

Optionally, the light-emitting marker is a particulate marker dispersed in the sample and wherein the particles comprise the light-emitting material and an inorganic matrix.

Optionally, a biomolecule configured to bind to the target analyte is bound directly or indirectly to the inorganic matrix.

In some embodiments, the present disclosure provides a light-emitting marker precursor comprising a light-emitting compound and a functional group wherein the light-emitting material comprises a group of formula (I):

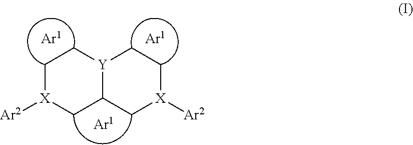

wherein X is one of N and B;

Y is the other of N and B;

Ar¹ independently in each occurrence is an aromatic or heteroaromatic group which is unsubstituted or substituted with one or more substituents;

Ar² in each occurrence is an aromatic or heteroaromatic group which is unsubstituted or substituted with one or more substituents; and

Ar¹ and Ar² bound to the same X group may be linked by a direct bond or a divalent group.

The light-emitting material comprising the group of formula (I) of the light-emitting marker precursor may be as described anywhere herein.

Optionally, the functional group is biotin.

Optionally, the light-emitting marker precursor is in particulate form.

In some embodiments, the present disclosure provides a formulation comprising the light-emitting marker precursor dissolved or dispersed in one or more solvents.

In some embodiments, the present disclosure provides a light-emitting marker comprising a light-emitting compound and a binding group comprising a biomolecule wherein the light-emitting material comprises a group of formula (I):

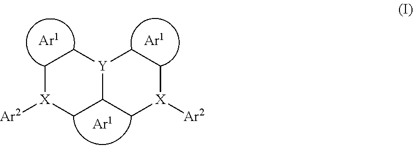

wherein X is one of N and B;

Y is the other of N and B;

Ar¹ independently in each occurrence is an aromatic or heteroaromatic group which is unsubstituted or substituted with one or more substituents;

Ar² in each occurrence is an aromatic or heteroaromatic group which is unsubstituted or substituted with one or more substituents; and

Ar¹ and Ar² bound to the same X group may be linked by a direct bond or a divalent group.

In some embodiments, the present disclosure provides a solution comprising the light-emitting marker described herein dissolved in a solvent.

In some embodiments, the present disclosure provides a method of forming the light-emitting marker described herein, the method comprising reacting the light-emitting marker precursor described herein with a material for forming the binding group.

In some embodiments, the present disclosure provides a light-emitting particle comprising a light-emitting material comprising a group of formula (I):

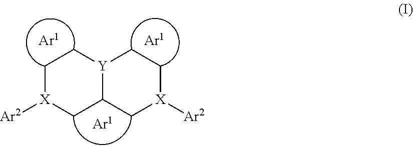

wherein X is one of N and B;

Y is the other of N and B;

Ar¹ independently in each occurrence is an aromatic or heteroaromatic group which is unsubstituted or substituted with one or more substituents;

Ar² in each occurrence is an aromatic or heteroaromatic group which is unsubstituted or substituted with one or more substituents; and

Ar¹ and Ar² bound to the same X group may be linked by a direct bond or a divalent group.

Optionally, the light-emitting particle comprises the light-emitting material mixed with or covalently bound to a matrix material.

Optionally, the matrix material is an inorganic oxide.

Optionally, the inorganic oxide is silica.

Optionally, the light-emitting particle comprises a core and a shell and wherein the light-emitting material is disposed in at least one of the core and the shell.

Optionally, a functional group is bound to a surface of the light-emitting particle. Optionally, the functional group is biotin.

In some embodiments, the present disclosure provides a method of forming a light-emitting particle as described herein wherein a monomer for forming silica is polymerised in the presence of the light-emitting material.

In some embodiments, the present disclosure provides a dispersion comprising light-emitting particles described herein dispersed in a liquid.

### DESCRIPTION OF THE DRAWINGS

The disclosed technology and accompanying figures describe some implementations of the disclosed technology.

FIG. 1 illustrates a flow cytometer for use in a method according to some embodiments.

The drawings are not drawn to scale and have various viewpoints and perspectives. The drawings are some implementations and examples. Additionally, some components and/or operations may be separated into different blocks or combined into a single block for the purposes of discussion of some of the embodiments of the disclosed technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to an atom include any isotope of that atom unless stated otherwise.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present inventors have identified certain light-emitting materials suitable for use in light-emitting markers for detection of a target analyte in a sample by binding of the light-emitting marker to the target analyte, such as detection of target cells in flow cytometry. The materials may have a narrow emission band, e.g. a narrow full width at half maximum (FWHM), which may limit or avoid overlap with emission from any further light-emitting markers which may be present in the sample, e.g. as in a multiplex flow cytometry assay. Thus, the light-emitting marker described herein (the “first light-emitting marker”) may be used in combination with one or more additional light-emitting markers which contain a light-emitting material which is different from the light-emitting material of the first light-emitting marker and which emit light at a peak wavelength different from that of the first light-emitting marker.

A narrow emission band of the light-emitting markers described herein may reduce or eliminate “false positive” detections arising from a further light-emitting marker having an emission band which overlaps with that of the first light-emitting marker, and/or reduce or eliminate the need for compensation due to “cross-talk” arising from detection of light emitted by a further light-emitting marker.

Additionally, by use of a light-emitting marker having a narrow FWHM, a greater proportion of light emitted from the light-emitting marker may reach a photodetector configured to detect this light as compared to a light-emitting marker having a wider FWHM, if light emitted from the light-emitting marker must pass through a bandpass emission filter before reaching the photodetector.

In some embodiments, a binding group having affinity for a target analyte is bound, preferably covalently bound, to the light-emitting material. In the case where the light-emitting material is a polymer, the binding group may be provided as a side group of a repeat unit of the light-emitting polymer or as an end-group of the light-emitting polymer. In some embodiments, the light-emitting material in use, e.g. in flow cytometry, may be dissolved or dispersed in a sample to be analysed. In the case where it is dissolved, the light-emitting material is preferably dissolved in water.

In some embodiments, the light-emitting marker is a particulate marker comprising a matrix material and the light-emitting material. The matrix material is preferably an inorganic matrix material, e.g. silica. According to these embodiments, the binding group may be bound, preferably covalently bound, to the matrix. In use, e.g. during flow cytometry, the particulate light-emitting marker may be dispersed in a sample to be analysed.

The binding group as described herein may be a biomolecule or a combination of biomolecules.

### Light-Emitting Material

The light-emitting material contains a group of formula (I):

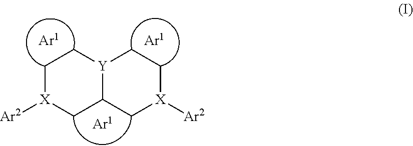

X is one of N and B and Y is the other of N and B.

Ar¹ and Ar² are each, independently in each occurrence, an aromatic or heteroaromatic group which is unsubstituted or substituted with one or more substituents.

Ar¹ and Ar² bound to the same X group may be linked by a direct bond or a divalent group, e.g. O, S or NR¹¹ wherein R¹¹ is a substituent, optionally a C₁₋₂₀ hydrocarbyl group.

In some embodiments, the group of formula (I) has formula (Ia):

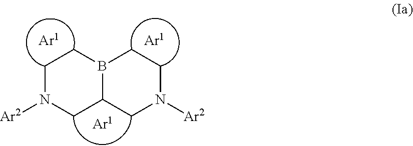

In some embodiments, the group of formula (I) has formula (Ib):

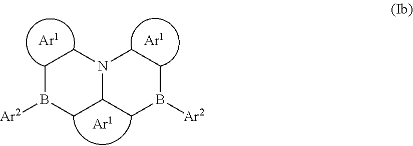

In some embodiments, the light-emitting material is a non-polymeric compound of formula (I), e.g. a non-polymeric compound of formula (Ia) or (Ib). The non-polymeric compound optionally has a molecular weight of less than 5,000 Daltons, optionally less than 3,000 Daltons.

In some embodiments, the light-emitting material is a polymer comprising a repeat unit comprising or consisting of a group of formula (I). Preferably, the polystyrene-equivalent number-average molecular weight (Mn) measured by gel permeation chromatography of the polymer is in the range of about 5×10³ to 1×10⁸, and preferably 1×10⁴ to 5×10⁶. The polystyrene-equivalent weight-average molecular weight (Mw) of the polymer may be 1×10³ to 1×10⁸, and preferably 1×10⁴ to 1×10⁷.

The group of formula (I) may be disposed in the backbone of the light-emitting polymer. In these embodiments, the polymer may comprise a repeat unit of formula (Ir):

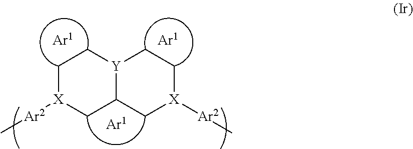

The group of formula (I) may be pendant from the backbone of the light-emitting polymer. I these embodiments, a repeat unit of the light-emitting polymer may be substituted with a group of formula (I).

Preferably, Ar¹ in each occurrence is a C₆₋₂₀ aromatic group, more preferably benzene or fluorene, which is unsubstituted or substituted with one or more substituents R¹.

Preferably, Ar² in each occurrence is a C₆₋₂₀ aromatic, more preferably benzene, which may be unsubstituted or substituted with one or more substituents R².

Where present, R¹ and R² may each independently be selected from:

F;

CN;

NO2;

C₁₋₂₀ alkyl wherein one or more non-adjacent, non-terminal C atoms may be replaced with O, S, COO or CO and one or more H atoms of the alkyl may be replaced with F;

an aromatic or heteroaromatic group Ar³ which is unsubstituted or substituted with one or more substituents; and

an ionic substituent.

In some embodiments, Ar³ maybe an aromatic group, e.g. phenyl. Where present, substituents of Ar³ may be selected from R⁸, wherein R⁸ independently in each occurrence is selected from F, CN, NO₂ and C₁₋₂₀ alkyl wherein one or more non-adjacent, non-terminal C atoms may be replaced with O, S, COO or CO and one or more H atoms of the alkyl may be replaced with F.

Preferably, an ionic substituent as described herein has formula (II):

-(Sp)ₘ-(R³)ₙ (II)

wherein Sp is a spacer group; m is 0 or 1; R³ independently in each occurrence is an ionic group; n is 1 if m is 0 and n is at least 1, optionally 1, 2, 3 or 4, if m is 1.

Preferably, Sp is selected from:
C₁₋₂₀ alkylene or phenylene-C₁₋₂₀ alkylene wherein one or more non-adjacent C atoms may be replace with O, S, N or C═O;
a C₆₋₂₀ arylene or 5-20 membered heteroarylene, more preferably phenylene, which, other than the one or more ionic groups R³, may be unsubstituted or substituted with one or more non-ionic substituents, optionally one or more non-ionic substituents R⁸ as described above.

More preferably, Sp is selected from:
C₁₋₂₀ alkylene wherein one or more non-adjacent C atoms may be replaced with O, S or CO; and
a C₆₋₂₀ arylene or a 5-20 membered heteroarylene, even more preferably phenylene, which may be unsubstituted or substituted with one or more non-ionic substituents.

In a preferred embodiment, Sp is a C₆₋₂₀ arylene or 5-20 membered heteroarylene, more preferably phenylene, substituted with a group of formula (III):

—O(R⁴O)ᵥ—R⁵ (III)

wherein R⁴ in each occurrence is a C₁₋₁₀ alkylene group, optionally a C₁₋₅ alkylene group, wherein one or more non-adjacent, non-terminal C atoms of the alkylene group may be replaced with O, R⁵ is H or C₁₋₅ alkyl, and v is 0 or a positive integer, optionally 1-10. Preferably, v is at least 2. More preferably, v is 2 to 5. The value of v may be the same in all the polar groups of formula —O(R⁴O)ᵥ—R⁵. The value of v may differ between different groups of formula (II) of the same polymer.

Optionally, the group of formula (III) has formula —O(CH₂CH₂O)ᵥR⁵ wherein v is at least 1, optionally 1-10 and R⁵ is a C₁₋₅ alkyl group, preferably methyl. Preferably, v is at least 2. More preferably, v is 2 to 5, most preferably v is 3.

The ionic group R³ may be anionic or cationic.

Exemplary anionic group are —COO⁻, a sulfonate group; hydroxide; sulfate; phosphate; phosphinate; or phosphonate.

An exemplary cationic group is —N(R⁶)₃⁺ wherein R⁶ in each occurrence is H or C₁₋₁₂ hydrocarbyl. Preferably, each R⁶ is a C₁₋₁₂ hydrocarbyl.

A light-emitting material comprising cationic or anionic groups comprises counterions to balance the charge of these ionic groups. An anionic or cationic group and counterion may have the same valency, with a counterion balancing the charge of each anionic or cationic group. The anionic or cationic group may be monovalent or polyvalent. Preferably, the anionic and cationic groups are monovalent.

The light-emitting material may comprise a plurality of anionic or cationic polar groups wherein the charge of two or more anionic or cationic groups is balanced by a single counterion. Optionally, the polar groups comprise anionic or cationic groups comprising di- or trivalent counterions.

In the case of an anionic group, the cation counterion is optionally a metal cation, optionally Li⁺, Na⁺, K⁺, Cs⁺, preferably Cs⁺, or an organic cation, optionally ammonium, such as tetraalkylammonium, ethylmethyl imidazolium or pyridinium.

In the case of a cationic group, the anion counterion is optionally a halide; a sulfonate group, optionally mesylate or tosylate; hydroxide; carboxylate; sulfate; phosphate; phosphinate; phosphonate; or borate.

By “non-terminal C atom” of an alkyl group as used herein means a C atom other than the methyl group at the end of an n-alkyl chain or the methyl groups at the ends of a branched alkyl chain.

Exemplary repeat units of formula (I) include:

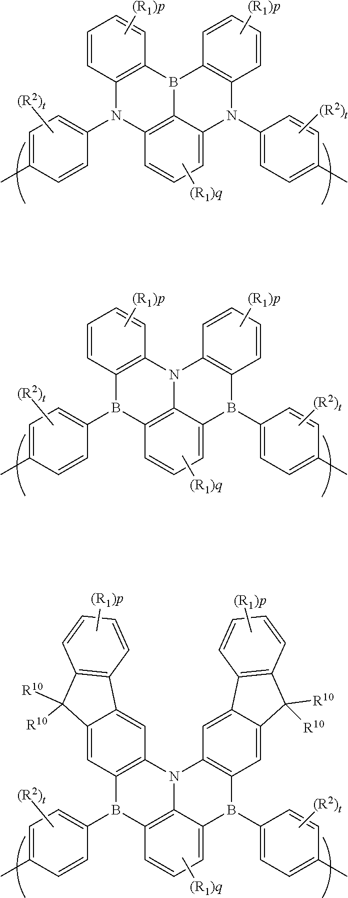

Exemplary non-polymeric compounds of formula (I) include:

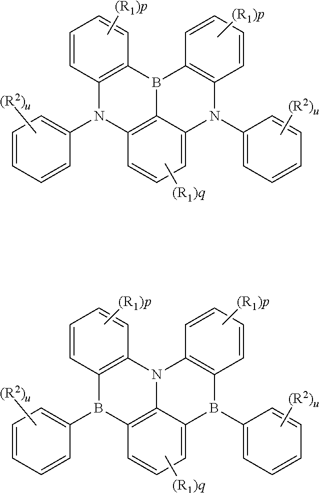

wherein R¹ and R² are as described above; p is 0, 1, 2, 3 or 4; q is 0, 1, 2 or 3; t is 0, 1, 2, 3 or 4; and u is 0, 1, 2, 3, 4 or 5.

A light-emitting polymer comprising a repeat unit comprising a group of formula (I) is preferably a copolymer comprising one or more co-repeat units.

A light-emitting polymer as described herein is preferably a conjugated polymer. Preferably, the polymer comprises a co-repeat unit comprising an aromatic group which is conjugated to the repeat unit of formula (I).

Preferably, the polymer comprises one or more C₆₋₂₀ arylene co-repeat. Exemplary arylene co-repeat units include, without limitation, fluorene, preferably a 2,7-linked fluorene; phenylene, preferably a 1,4-linked phenylene; naphthalene, anthracene, indenofluorene, phenanthrene and dihydrophenanthrene repeat units, each of which may independently be unsubstituted or substituted with one or more substituents.

Arylene co-repeat units may be selected from repeat units of formulae (IV)-(VII):

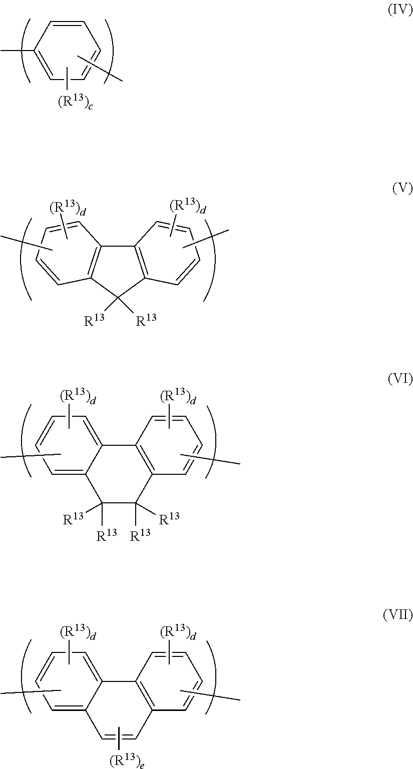

wherein R¹³ in each occurrence is a substituent; c is 0, 1, 2, 3 or 4, preferably 1 or 2; d is 0, 1, 2, 3 or 4, preferably 1 or 2; and e is 0, 1 or 2, preferably 2.

Optionally, each R¹³ is independently selected from:
C₁₋₂₀ alkyl wherein one or more non-adjacent, non-terminal C atoms may be replaced with O, S, COO or CO and one or more H atoms of the alkyl may be replaced with F;
an aromatic or heteroaromatic group Ar³ which is unsubstituted or substituted with one or more substituents; and
an ionic substituent.

Ar³ groups and ionic substituents of formulae (IV)-(VII) are preferably selected from Ar³ and ionic substituents as described above with reference to R¹ and R².

Preferably, repeat units of formula (Ir) make up 0.1-20 mol % of the repeat units of a copolymer as described herein, optionally 0.5-10 mol %.

Conjugated light-emitting polymers as described herein may be formed by polymerising monomers comprising leaving groups that leave upon polymerisation of the monomers to form conjugated repeat units. Exemplary polymerization methods include, without limitation, Yamamoto polymerization as described in, for example, T. Yamamoto, “Electrically Conducting And Thermally Stable pi-Conjugated Poly(arylene)s Prepared by Organometallic Processes”, Progress in Polymer Science 1993, 17, 1153-1205, the contents of which are incorporated herein by reference and Suzuki polymerization as described in, for example, WO 00/53656, WO 2003/035796, and U.S. Pat. No. 5,777,070, the contents of which are incorporated herein by reference.

The light-emitting material preferably has a solubility in water or a C₁₋₆ alcohol, preferably methanol, at 20° C. of at least 0.1 mg/ml.

To provide solubility in water, the substituents of the light-emitting material may include one or more polar, non-ionic substituents and/or ionic substituents.

In the case where the light-emitting material is a light-emitting polymer, the repeat unit comprising the group of formula (I) and/or a co-repeat unit of the light-emitting polymer may be substituted with one or more substituents selected from polar, non-ionic substituents and/or ionic substituents.

In some embodiments, the repeat unit of formula (I) is substituted with an ionic substituent, e.g. a group of formula (II) and/or a polar, non-ionic substituent, e.g. a group of formula (III).

In some embodiments, the light-emitting polymer is a copolymer comprising one or more co-repeat units wherein at least one co-repeat unit of the polymer is substituted with an ionic substituent, e.g. a group of formula (II) and/or a polar, non-ionic substituent, e.g. a group of formula (III).

In some preferred embodiments, at least one substituent of the light-emitting material is selected from from —O(R⁴O)ᵥ—R⁵ and/or ionic groups, more preferably groups of formula —O(CH₂CH₂O)ᵥR⁵ and —COO⁻.

The light-emitting material preferably has an emission peak wavelength of 500 nm or less, preferably in the range of 400-500 nm. The emission peak preferably has a FWHM of less than 50 nm, preferably less than 40 nm.

Mechanisms for energy transfer include, for example, resonant energy transfer; Forster (or fluorescence) resonance energy transfer (FRET), quantum charge exchange (Dexter energy transfer) and the like

In some preferred embodiments, a peak of an emission spectrum of a light-emitting copolymer as described herein overlaps with a peak of an absorption spectrum of the light-emitting copolymer and emission is by FRET.

Unless stated otherwise, emission spectra of light-emitting markers as described herein are as measured in water, using a Hamamatsu C9920-02 instrument having a set up wavelength 300 nm-950 nm; light source 150 W xenon light and bandwidth l0nm or less (FWHM). Initially the system was calibrated with red (395 nm), green (375 nm) and blue (335 nm) glass standards. Two 5 ml long necked cuvettes (one filled with reference solvent i.e. water) and one filled with a sample of 1 mg/ml diluted 1 in 100 for a dissolved light-emitting marker or 1mg/ml diluted ˜1 in 10 with water for a particulate light-emitting marker. The final concentration of the sample was altered to obtain a transmission data in the range 0.25-0.35. An average of 3 measurements for each sample is recorded.

Unless stated otherwise, absorption spectra of light-emitting materials as described herein are measured in water using a Cary 5000 UV-VIS-NIR Spectrometer. Measurements were taken from 175 nm to 3300 nm using a PbSmart NIR detector for extended photometric range with variable slit widths (down to 0.01 nm) for optimum control over data resolution. A baseline run with water in front and back 5 ml matched cuvettes (600 to 250nm) following which the back cuvette reference remained as water and the front cuvette was changed to a sample of 1 mg/ml diluted 1 in 100 for a dissolved light-emitting marker or 1 mg/ml diluted ˜1 in 10 with water for a particulate light-emitting marker.

### Light-Emitting Particle

The light-emitting marker may be in the form of a light-emitting particle comprising or consisting of the light-emitting material.

In some embodiments, formation of a light-emitting nanoparticle comprising or consisting of a polymer as described herein may include collapse of the light-emitting polymer.

In some embodiments, the particle may have a particulate core and, optionally, a shell wherein at least one of the core and shell contains the light-emitting material. Preferably, the light-emitting particle contains the light-emitting material and a matrix material. Matrix materials include, without limitation, inorganic matrix materials, optionally inorganic oxides, optionally silica.

Polymer chains of a light-emitting polymer may extend across some or all of the thickness of the core and/or shell. Polymer chains may be contained within the core and/or shell or may protrude through the surface of the core and/or shell.

The matrix may at least partially isolate the light-emitting material from the surrounding environment. This may limit any effect that the external environment may have on the lifetime of the light-emitting material.

The light-emitting material may be mixed with the matrix material.

The light-emitting material may be bound, e.g. covalently bound, to the matrix material.

In some embodiments, the particle core may be formed by polymerisation of a silica monomer in the presence of the light-emitting material, for example as described in WO 2018/060722, the contents of which are incorporated herein by reference.

In some embodiments, the particle core comprises a core which comprises or consists of the light-emitting polymer and at least one shell surrounding the inner core. The at least one shell may be silica.

Optionally, at least 0.1 wt % of total weight of the particle core consists of the light-emitting polymer. Preferably at least 1, 10, 25 wt % of the total weight of the particle core consists of the light-emitting material.

Optionally at least 50 wt % of the total weight of the particle core consists of the matrix material. Preferably at least 60, 70, 80, 90, 95, 98, 99, 99.5, 99.9 wt % of the total weight of the particle core consists of the matrix material.

The particle core as described herein is the light-emitting particle without any surface groups, e.g. binding groups or solubilising groups, thereon.

In one embodiment of the present disclosure, at least 70 wt % of the total weight of the particle core consists of the light-emitting material or materials and silica. Preferably at least 80, 90, 95, 98, 99, 99.5, 99.9 wt % of the total weight of the particle core consists of the light-emitting material and silica. More preferably the particle core consists essentially of the light-emitting material and silica.

Preferably, the particles have a number average diameter of no more than 5000 nm, more preferably no more than 2500 nm, 1000 nm, 900 nm, 800 nm, 700 nm, 600 nm, 500 nm or 400 nm as measured by dynamic light scattering (DLS) using a Malvern Zetasizer Nano ZS. Preferably the particles have a number average diameter of between 5-5000 nm, optionally 10-1000 nm, preferably between 10-500 nm, most preferably between 10-100 nm as measured by a Malvern Zetasizer Nano ZS.

Light-emitting particles as described herein may be provided as a colloidal suspension comprising the particles suspended in a liquid. Preferably, the liquid is selected from water, C₁₋₁₀ alcohols and mixtures thereof. Preferably, the particles form a uniform (non-aggregated) colloid in the liquid.

The liquid may be a solution comprising salts dissolved therein, optionally a buffer solution.

In some embodiments, the particles may be stored in a powder form, optionally in a lyophilised or frozen form.

### Functional Groups

The binding group of the light-emitting marker for binding to a target analyte may be formed by reaction of a functional group of a precursor of the light-emitting marker.

Optionally the functional group is selected from:

amine groups, optionally —NR⁹₂ wherein R⁹ in each occurrence is independently H or a substituent, preferably H or a C₁₋₅ alkyl, more preferably H;

carboxylic acid or a derivative thereof, for example an anhydride, acid chloride or ester, acid chloride, acid anhydride or amide group;

—OH; —SH; an alkene; an alkyne; and an azide; and

biotin or a biotin-protein conjugate.

The functional group may be reacted with a biomolecule to form a linking group linking the biomolecule to the rest of the light-emitting marker, the linking group being selected from esters, amides, urea, thiourea, Schiff bases, a primary amine (C—N) bond, a maleimide-thiol adduct or a triazole formed by the cycloaddition of an azide and an alkyne.

Exemplary binding group biomolecules for binding to a target analyte include, without limitation, DNA, RNA, peptides, carbohydrates, antibodies, antigens, enzymes, proteins, hormones and combinations thereof.

In the case where the functional group is biotin, it may be conjugated to a protein, e.g. avidin, streptavidin, neutravidin and recombinant variants thereof, and a biotinylated biomolecule may be conjugated to the protein to form the light-emitting marker.

The biotinylated biomolecule may comprise an antigen binding fragment, e.g. an antibody, which may be selected according to a target antigen.

In the case of a light-emitting particle, the functional group may be bound to a surface of the particle core, e.g. bound to a matrix material of the light-emitting particle core. Each functional group may be directly bound to the surface of a light-emitting particle core or may be spaced apart therefrom by one or more surface binding groups. The surface binding group may comprise polar groups. Optionally, the surface binding group comprises a polyether chain. By “polyether chain” as used herein is meant a chain having two or more ether oxygen atoms.

The surface of a light-emitting particle core may be reacted to form a group at the surface capable of attaching to a functional group. Optionally, a silica-containing particle is reacted with a siloxane.

### Applications

Light-emitting markers as described herein may be used as luminescent probes for detecting or labelling a biomolecule or a cell. In some embodiments, the particles may be used as a luminescent probe in an immunoassay such as a lateral flow or solid state immunoassay. Optionally the particles are for use in fluorescence microscopy, flow cytometry, next generation sequencing, in-vivo imaging, or any other application where a light-emitting marker is brought into contact with a sample to be analysed. The analysis may be performed using time-resolved spectroscopy. The applications can medical, veterinary, agricultural or environmental applications whether involving patients (where applicable) or for research purposes.

In use the binding group of the light-emitting markers may bind to target biomolecules which include without limitation DNA, RNA, peptides, carbohydrates, antibodies, antigens, enzymes, proteins and hormones. The target biomolecule may be a biomolecule, e.g. a protein, at a surface of a cell.

A sample to be analysed may brought into contact with the light-emitting marker, for example the light-emitting marker dissolved in a solution or a particulate light-emitting marker in a colloidal suspension.

In some embodiments, the sample is analysed by flow cytometry. In flow cytometry, the light-emitting marker or markers are irradiated by at least one wavelength of light, optionally two or more different wavelengths, e.g. one or more wavelengths including at least one of about 355, 405, 488, 530, 561 and 640 nm, each of which may be ±10 nm. Light emitted by the light-emitting marker(s) may be collected by one or more detectors. To provide a background signal for calculation of a staining index, measurement may be made of a light-emitting marker mixed with cells which do not bind to the light-emitting marker.

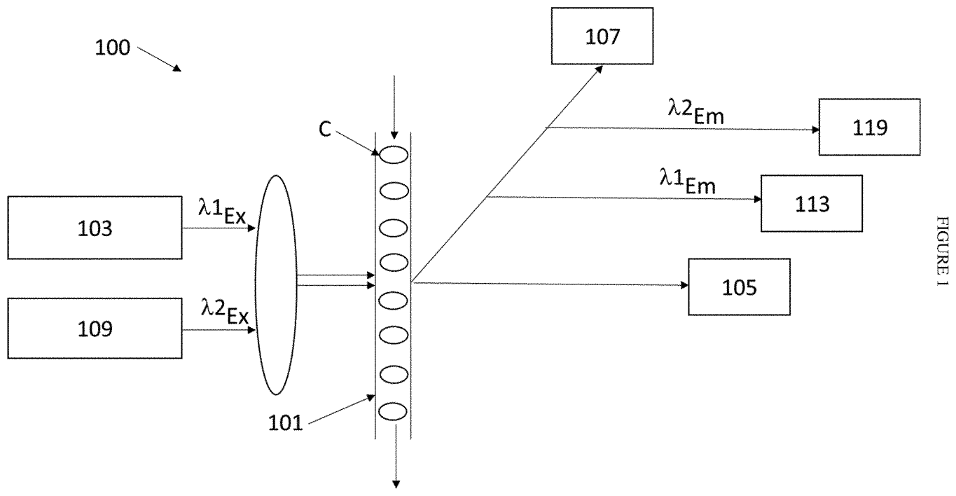

FIG. 1 schematically illustrates flow cytometer 100 which may be used in some embodiments of the flow cytometry methods of the present disclosure.

The flow cytometer comprises a flow channel 101 through which cells may pass in a single file; a first light source 103, e.g. a laser, configured to irradiate the flow channel with light of a first excitation wavelength λ1Ex; a forward scatter detector 105; a side scatter detector 107; and a first photodetector 113 configured to detect light of a first emission wavelength λ1Em emitted from a first light-emitting marker bound to a cell upon excitation by the first excitation wavelength λ1Ex, wherein the first light-emitting marker comprises a light-emitting material as described herein.

The apparatus may further comprise at least one further light source 105, e.g. a laser, configured to irradiate the flow channel with light of a second excitation wavelength λ2Ex and a photodetector configured to detect light of a second emission wavelength λ2Em emitted from at least one further light-emitting marker bound to a cell upon excitation by the second excitation wavelength λ2Ex.

A first emission bandpass filter may be disposed in a light path between the flow channel and the first photodetector. The emission bandpass filter may have a transmission maximum in the range of 450-470 nm. It will be appreciated that a greater proportion of light having a peak emission wavelength λ1Em falling within the transmission maximum of the bandpass filter will reach the first photodetector if the FWHM of this light is narrower.

The one or more further light-emitting markers contain a light-emitting material which is different from the light-emitting material of the first light-emitting marker. λ1Em and λ2Em are different.

For simplicity, FIG. 1 illustrates a flow cytometer having only two light sources and only two photodetectors however it will be understood that in other embodiments the flow cytometer may have more than two light sources and/or more than two photodetectors.

In some embodiments, a single light source may be configured to excite a single light-emitting marker of a plurality of light-emitting markers present in a sample being analysed or may be configured to excite a plurality of different light-emitting markers. It will therefore be appreciated that the flow cytometer may include only one light source.

In some embodiments, a sample to be analysed contains a plurality of light-emitting markers including a first light-emitting marker as described herein. Preferably, the first light-emitting marker has a full width at half maximum (FWHM) of less than 50 nm. Preferably, the first light-emitting marker has a peak emission wavelength which is separated by at least 50 nm from the peak of the light-emitting materials of the one or more further light-emitting markers.

Signals received by the forward scatter detector, side scatter detector and photodetectors may be transmitted by wired or wireless transmission to a signal processor (not shown).

### EXAMPLES

### Monomer Example 1

Monomer Example 1 was prepared according to the following reaction scheme:

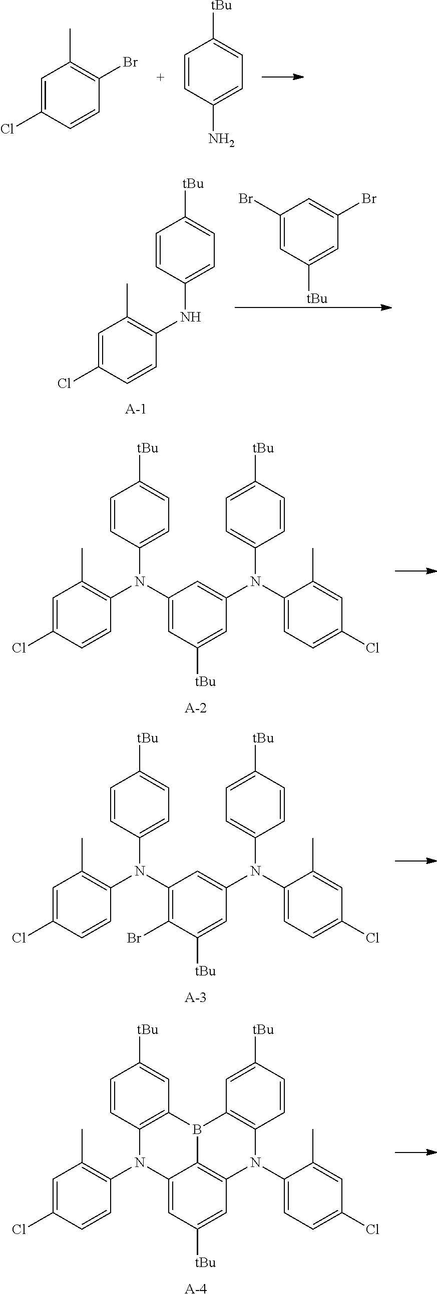

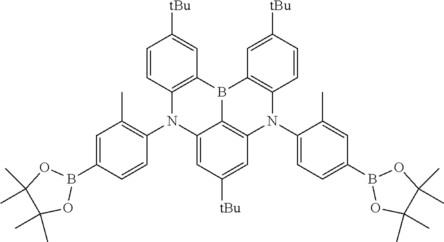

### Monomer Example 1

### Synthesis of Compound A-1

23.88 g of 4-tert-Butylaniline, 0.45 g of tris(dibenzylideneacetone)dipalladium(0), 0.24 g of tri-tert-butylphosphine tetrafluoroborate and 19.22 g of Sodium tert-butoxide were added to a flask, and the atmosphere in the flask was purged with nitrogen. 330 ml of dehydrated toluene was added thereto and the mixture was heated to 80 C in an oil bath. Toluene solution (55 ml) of 27.40 g of 2-Bromo-5-chlorotoluene was added dropwise thereto for 0.5 hour, then stirred for 0.5 hour at 80° C. The solution was cooled to room temperature, and 330 ml of heptane and 36.5 g of silicagel were added, then the resultant was filtered through 73 g of silica gel, and washed with 330 ml of heptane/toluene solution. The filtrate was concentrated, and 42.06 g of crude product was obtained. The crude product was dissolved in 420 ml of heptane and 4.2 g of activated charcoal was added, and stirred for 15 min. Then the resultant was filtered through 210 g of silica gel, then washed with 3 L of heptane. The filtrate was concentrated, and 31.81 g of compound A-1 was obtained.

*¹H-NMR (CD₂Cl₂)

δ 1.27 (9H, s), 2.20 (3H, s), 5.33 (1H, s), 6.90 (2H, d), 7.02 (1H, dd), 7.07 (1H, d), 7.13 (1H, d), 7.27 (2H, d)

### Synthesis of Compound A-2

31.81 g of compound A-1, 1.56 g of tris(dibenzylideneacetone)dipalladium(0), 0.84 g of tri-tert-butylphosphine tetrafluoroborate and 13.29 g of Sodium tert-butoxide were added to a flask, and the atmosphere in the flask was purged with nitrogen. 290 ml of dehydrated toluene was added thereto and the mixture was heated to 50° C. in an oil bath. Toluene solution (32 ml) of 16.16 g of 5-(tert-Butyl)-1,3-dibromobenzene was added dropwise thereto for an hour, then stirred for an hour at 50 C. The solution was cooled to room temperature, and 320 ml of heptane and 37.5 g of celite (No.545) were added, then the resultant was filtered through 75 g of silica gel, and washed with 320 ml of heptane/toluene solution. The filtrate was concentrated, and 47.6 g of crude product was obtained. The crude product was purified by silica gel column chromatography (eluent:hexane and toluene), and 16.79 g of compound A-2 was obtained.

δ 1.06 (9H, s), 1.24 (18H, s), 1.94 (6H, s), 6.33 (1H, s), 6.40 (2H, s), 6.78 (4H, d), 6.98 (2H, d), 7.08-7.19 (8H, m)

### Synthesis of Compound A-3

14.80 g of compound A-2 and 370 ml of chloroform were added to a flask, and the solution was cooled to 0° C. 1.92 g of N-Bromosuccinimide was added thereto, and stirred for 6 hours.

10 g of 10% aqueous solution of Sodium sulfite was added thereto, and stirred for 0.5 hour. Then the organic layer was separated from aqueous layer, and washed with 150 ml of water twice. Then the solution was dried over magnesium sulfate, and evaporated to give 17.59 g of crude product. The crude product was dissolved in 90 ml of toluene and 1.76 g of activated charcoal was added, and stirred for 15 min. Then the resultant was filtered through 53 g of silica gel, then washed with 1 L of toluene. The filtrate was concentrated, and 170 ml of acetonitrile was added thereto and stirred for an hour. The slurry was filtered and the obtained solid was dried under vacuum, and 16.90 g of compound A-3 was obtained.

*¹H-NMR (CDCl₃)

δ 1.24 (9H, s), 1.28 (9H, s), 1.37 (9H, s), 1.93 (3H, s), 2.00 (3H, s), 6.52-6.59 (3H, m), 6.71-6.78 (4H, m), 6.97-7.02 (2H, m), 7.07-7.20 (7H, m)

### Synthesis of Compound A-4

15.50 g of compound A-3 was added to a flask, and the atmosphere in the flask was purged with nitrogen. 465 ml of dehydrated toluene was added thereto and cooled to −50° C. 22.3 ml of sec-BuLi solution (1.0 mol/L cyclohexane and hexane solution) was added dropwise for 15 min. Then, the temperature of reaction mixture was raised to −10° C., and stirred for 1 hour. Then the solution was cooled to −40° C., and 10.26 g of BBr₃ was added thereto. The solution was stirred for 1 hour at 50° C., then stirred for 1 hour at 100° C. Then the solution was cooled to room temperature and 465 ml of toluene, 26.48 g of diisopropylethylamine and 46.5 g of 10% aqueous solution of Sodium sulfite were added. The organic layer was separated from aqueous layer and washed with 90 ml of water. Then magnesium sulfate was added to thereto, and stirred for 0.5 hour. Then the solution was filtered through 42 g of silica gel. The filtrate was evaporated to give 17.17 g of crude product. The crude product was purified by silica gel column chromatography (eluent:hexane and toluene), and 7.25 g of compound A-4 was obtained.

*TLC-MS(DART)

685.3 ([M+H]⁺, Exact Mass: 684.3)

### Synthesis of Monomer Example 1

5.50 g of compound A-4, 6.11 g of bis(pinacolato)diboron, 4.72 g of potassium acetate, 0.23 g of tris(dibenzylideneacetone)dipalladium(0) and 0.40 g of 2-Dicyclohexylphosphino-2′,4′,6′-triisopropylbiphenyl were added to a flask, and the atmosphere in the flask was purged with nitrogen. 82 ml of dehydrated toluene and 110 ml of dehydrated 1,2-dimethoxyethane were added thereto and heated to 85° C. in an oil bath. The solution was stirred for 13 hours at 85° C., then cooled to room temperature. 240 ml of toluene was added thereto, then filtered through 21 g of silica gel and washed with 240 ml of toluene. 2.25 g of activated charcoal was added to the filtrate, and stirred for 0.5 hour at room temperature, then activated charcoal was removed by filtration. The filtrate was evaporated to give 6.80 g of crude product. The crude product was purified by recrystallization (toluene/acetonitrile solvent) 3 times, then 4.28 g of Monomer Example 1 was obtained.

*TLC-MS (DART)

869.5 ([M+H]⁺, Exact Mass: 868.6)

*¹H-NMR (CDCl₃)

δ 1.00 (9H, s), 1.43 (18H, s), 1.47 (24H, s), 1.97 (3H, s), 1.99 (3H, s), 6.12 (2H, s), 6.58 (2H, d), 7.29 (2H, dd), 7.44 (2H, dd, 7.91 (2H, d), 7.98 (2H, s), 9.01 (2H, dd)

### Polymer Example 1

A polymer was prepared by Suzuki polymerisation of 5 mol % of Monomer Example 1 and 95 mol % of monomers for forming the fluorene repeat unit illustrated below, made up of 50 mol % of monomers having halide leaving groups and 45 mol % of monomers having a picolinate ester of a boronic acid leaving group:

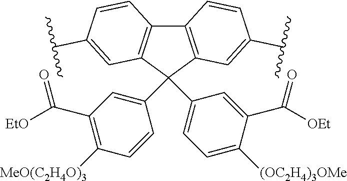

Following polymerisation, ester substituent groups of the fluorene repeat unit were hydrolysed to —COO⁻Cs⁺ groups as described in WO 2012/133229, the contents of which are incorporated herein by reference.

### Comparative Polymer 1

For the purpose of comparison, a polymer was formed as described for Polymer Example 1 except that 100 mol % of the repeat units of the polymer were of the fluorene repeat unit.

With reference to Table 1, Polymer Example 1 has a smaller FWHM than Comparative Polymer 1.

TABLE 1

| | FWHM in | FWHM in |
|---|---|---|
| Polymer | methanol (nm) | toluene (nm) |
| Polymer Example 1 | 32 | 24 |
| Comparative Polymer 1 | 50 | 45 |

1. A method of identifying a target analyte in a sample, the method comprising irradiating the sample to which has been added a first light-emitting marker configured to bind to the target analyte; and detecting emission from the light-emitting marker, wherein the light-emitting marker comprises a light-emitting material comprising a group of formula (I): 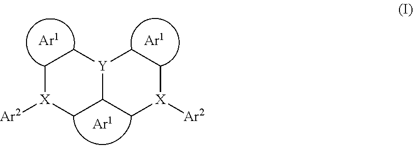
wherein X is one of N and B;
Y is the other of N and B;
Ar¹ independently in each occurrence is an aromatic or heteroaromatic group which is unsubstituted or substituted with one or more substituents;
Ar² in each occurrence is an aromatic or heteroaromatic group which is unsubstituted or substituted with one or more substituents; and
Ar¹ and Ar² bound to the same X group may be linked by a direct bond or a divalent group.

2. The method according to claim 1 wherein the light-emitting material is a polymer comprising a repeat unit comprising a group of formula (I).

3. The method according to claim 2 wherein the light-emitting material is a polymer comprising a repeat unit of formula (Ir):

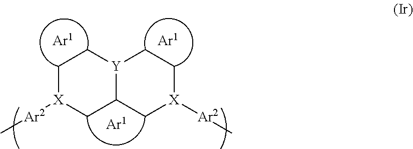

4. The method according to claim 2 wherein the light-emitting polymer is a copolymer comprising the repeat unit of formula (I) and at least one co-repeat unit.

5. The method according to claim 4 wherein the polymer comprises a C₆₋₂₀ arylene co-repeat unit.

6. The method according to claim 1 wherein the light-emitting marker comprises a biomolecule configured to bind to the target analyte.

7. The method according to claim 1 wherein the light-emitting material has a solubility in water or a C₁₋₆ alcohol of at least 0.1 mg/ml.

8. The method according to claim 1 wherein the light-emitting material is substituted with at least one ionic substituent.

9. The method according to claim 1 wherein the light-emitting material is substituted with at least one group of formula (III):
—O(R⁴O)ᵥ—R⁵ (III)
wherein R⁴ in each occurrence is a C₁₋₁₀ alkylene group wherein one or more non-adjacent, non-terminal C atoms of the alkylene group may be replaced with O, R⁵ is H or C₁₋₅ alkyl, and v is 0 or a positive integer.

10. The method according to claim 1 wherein the light-emitting polymer has a peak emission wavelength (λ_{Em}) in the range of 400-500 nm.

11. The method according to claim 1 wherein the light-emitting polymer has an emission peak having a full width at half maximum of less than 50 nm.

12. The method according to claim 1 wherein the sample comprises one or more additional light-emitting markers wherein each of the one or more additional light-emitting markers emits light having an emission peak which is different from that of the first light-emitting marker.

13. The method according to claim 1 wherein the method is a flow cytometry method and the target analyte is a target cell.

14. (canceled)

15. The method according to claim 1 wherein the first light-emitting marker is dissolved in the sample.

16. The method according to claim 1 wherein the light-emitting marker is a particulate marker dispersed in the sample and wherein the particles comprise the light-emitting material and an inorganic matrix.

17. (canceled)

18. A light-emitting marker precursor comprising a light-emitting compound and a functional group wherein the light-emitting material comprises a group of formula (I): 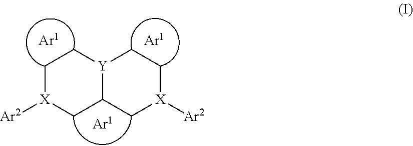
wherein X is one of N and B;
Y is the other of N and B;
Ar¹ independently in each occurrence is an aromatic or heteroaromatic group which is unsubstituted or substituted with one or more substituents;
Ar² in each occurrence is an aromatic or heteroaromatic group which is unsubstituted or substituted with one or more substituents; and
Ar¹ and Ar² bound to the same X group may be linked by a direct bond or a divalent group.

19. (canceled)

20. (canceled)

21. A formulation comprising the light-emitting marker precursor according to claim 18 dissolved or dispersed in one or more solvents.

22. A light-emitting marker comprising a light-emitting compound and a binding group comprising a biomolecule wherein the light-emitting material comprises a group of formula (I): 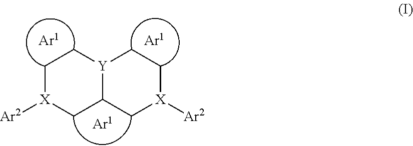
wherein X is one of N and B;
Y is the other of N and B;
Ar¹ independently in each occurrence is an aromatic or heteroaromatic group which is unsubstituted or substituted with one or more substituents;
Ar² in each occurrence is an aromatic or heteroaromatic group which is unsubstituted or substituted with one or more substituents; and
Ar¹ and Ar² bound to the same X group may be linked by a direct bond or a divalent group.

23. A solution comprising the light-emitting marker according to claim 22 dissolved in a solvent.

24. (canceled)

25. A light-emitting particle comprising a light-emitting material comprising a group of formula (I): 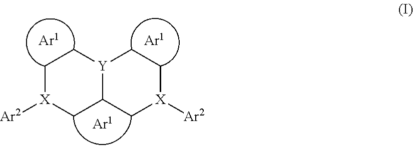
wherein X is one of N and B;
Y is the other of N and B;
Ar¹ independently in each occurrence is an aromatic or heteroaromatic group which is unsubstituted or substituted with one or more substituents;
Ar² in each occurrence is an aromatic or heteroaromatic group which is unsubstituted or substituted with one or more substituents; and
Ar¹ and Ar² bound to the same X group may be linked by a direct bond or a divalent group.

26-28. (canceled)
